(19) United States
(12) Patent Application Publication
(10) Pub. No.: US 2025/0297622 A1
(43) Pub. Date: Sep. 25, 2025

(54) MISTING FAN ASSEMBLY

(71) Applicant: Techtronic Cordless GP, Anderson, SC (US)

(72) Inventors: Bradley York, Piedmont, SC (US); Garrett Gerdes, Piedmont, SC (US); Jordan Harris, Greenville, SC (US); Curt Laugh, Easley, SC (US); Zachary Harrington, Mauldin, SC (US); Ryan Altenburger, Greenville, SC (US)

(21) Appl. No.: 19/079,835

(22) Filed: Mar. 14, 2025

Related U.S. Application Data
(60) Provisional application No. 63/569,440, filed on Mar. 25, 2024.

(51) Int. Cl. F04D 31/00; F04D 19/00; F04D 29/52

(52) U.S. Cl. CPC F04D 31/00; F04D 19/002; F04D 29/522

(57) ABSTRACT

A fan device is provided, the fan device including a fan and a mister assembly. The fan is configured to provide a flow of air through a fan flowpath. The mister assembly includes a casing having an outer body, a centerbody, and a vane extending between the outer body and the centerbody. A plenum is formed in the casing to store a cooling fluid. The plenum extends through the outer body, the vane, and the centerbody. The centerbody includes an opening through which the cooling fluid is releasable from the plenum into fluid communication with the flow of air.

### PRIORITY STATEMENT

The present application claims the benefit of priority to U.S. provisional patent application No. 63/569,440, filed Mar. 25, 2024, the disclosure of which is incorporated by reference herein in its entirety.

### FIELD

The present disclosure relates generally to fan devices and fan assemblies, and more particularly, to personal fan devices.

### BACKGROUND

Fan devices, such as personal fan devices, are generally designed to provide a flow of air for cooling a user. The fan device may generally be a portable device configured to be moved and articulated to provide the flow of air in one or more directions. It is generally desired to improve a cooling capacity of the fan device. However, additional structures and devices for improving cooling capacity may generally add weight, complexity, and cost to the fan device.

As such, a fan device that addresses one or more of these issues would be beneficial and advantageous.

### BRIEF DESCRIPTION

Aspects and advantages of the invention in accordance with the present disclosure will be set forth in part in the following description, or may be obvious from the description, or may be learned through practice of the technology.

An aspect of the present disclosure is directed to a fan device. The fan device includes a fan and a mister assembly. The fan is configured to provide a flow of air through a fan flowpath. The mister assembly includes a casing having an outer body, a centerbody, and a vane extending between the outer body and the centerbody. A plenum is formed in the casing to store a cooling fluid. The plenum extends through the outer body, the vane, and the centerbody. The centerbody includes an opening through which the cooling fluid is releasable from the plenum into fluid communication with the flow of air.

Another aspect of the present disclosure is directed to a fan device including a fan and a mister assembly. The fan is configured to provide a flow of air through a fan flowpath. The mister assembly includes a casing. The fan flowpath at least partially passes through a space surrounded by a periphery of the casing. A plenum is formed in the casing to store a cooling fluid. The casing includes an opening through which the cooling fluid is releasable from the plenum into fluid communication with the flow of air.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 depicts a first front perspective view of an exemplary embodiment of a fan device in accordance with aspects of the present disclosure;

FIG. 2A depicts a second front perspective view of the exemplary embodiment of the fan device of FIG. 1 in accordance with aspects of the present disclosure;

FIG. 2B depicts a front perspective view of an exemplary embodiment of a fan device in accordance with aspects of the present disclosure;

FIG. 3A depicts a rear perspective view of the exemplary embodiment of the fan device of FIG. 1 in accordance with aspects of the present disclosure;

FIG. 3B depicts a rear perspective view of the exemplary embodiment of the fan device of FIG. 2A in accordance with aspects of the present disclosure;

FIG. 4 depicts an exemplary embodiment of a fan device in a first orientation in accordance with aspects of the present disclosure;

FIG. 5 depicts the exemplary embodiment of the fan device of FIG. 4 in a second orientation in accordance with aspects of the present disclosure;

FIG. 6 depicts a perspective view of an embodiment of the fan device in accordance with aspects of the present disclosure;

FIG. 7 depicts an exploded view of an embodiment of a mister assembly for a fan device in accordance with aspects of the present disclosure;

FIG. 8 depicts a perspective view of the embodiment of the fan device of FIG. 6, with portions removed, in accordance with aspects of the present disclosure;

FIG. 9 depicts a cutaway view of an embodiment of a mister assembly for a fan device in accordance with aspects of the present disclosure;

FIG. 10 depicts a cutaway view of an embodiment of a mister assembly in a first orientation in accordance with aspects of the present disclosure;

FIG. 11 depicts a cutaway view of an embodiment of a mister assembly in a second orientation in accordance with aspects of the present disclosure;

FIG. 12 depicts a cutaway view of an embodiment of a mister assembly in a third orientation in accordance with aspects of the present disclosure;

FIG. 13 depicts a perspective view of a capillary structure for the mister assembly in accordance with aspects of the present disclosure;

FIG. 14 depicts a rear perspective view of an exemplary embodiment of a fan device, with components omitted for clarity, in accordance with aspects of the present disclosure;

FIG. 15 depicts a front perspective view of the fan device of FIG. 14, with components omitted for clarity, in accordance with aspects of the present disclosure;

FIG. 16 depicts a rear perspective view of the fan device of FIG. 14, with components omitted for clarity, in accordance with aspects of the present disclosure;

FIG. 17 depicts a rear perspective view of the fan device of FIG. 14, with components exploded for clarity, in accordance with aspects of the present disclosure;

FIG. 18 depicts a rear perspective view of the fan device of FIG. 14, with components exploded for clarity, in accordance with aspects of the present disclosure;

FIG. 19 depicts a rear perspective view of the fan device of FIG. 14, with components omitted for clarity, in accordance with aspects of the present disclosure;

FIG. 20 depicts a rear perspective view of the fan device of FIG. 14, with components exploded and omitted for clarity, in accordance with aspects of the present disclosure;

FIG. 21 depicts a rear perspective view of the fan device of FIG. 14, with components exploded and omitted for clarity, in accordance with aspects of the present disclosure;

FIG. 22 depicts a rear perspective view of an exemplary embodiment of a fan device in accordance with aspects of the present disclosure;

FIG. 23 depicts a rear view of the exemplary embodiment of the fan device of FIG. 22 in a first orientation in accordance with aspects of the present disclosure; and

FIG. 24 depicts a rear view of the exemplary embodiment of the fan device of FIG. 22 in a second orientation in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

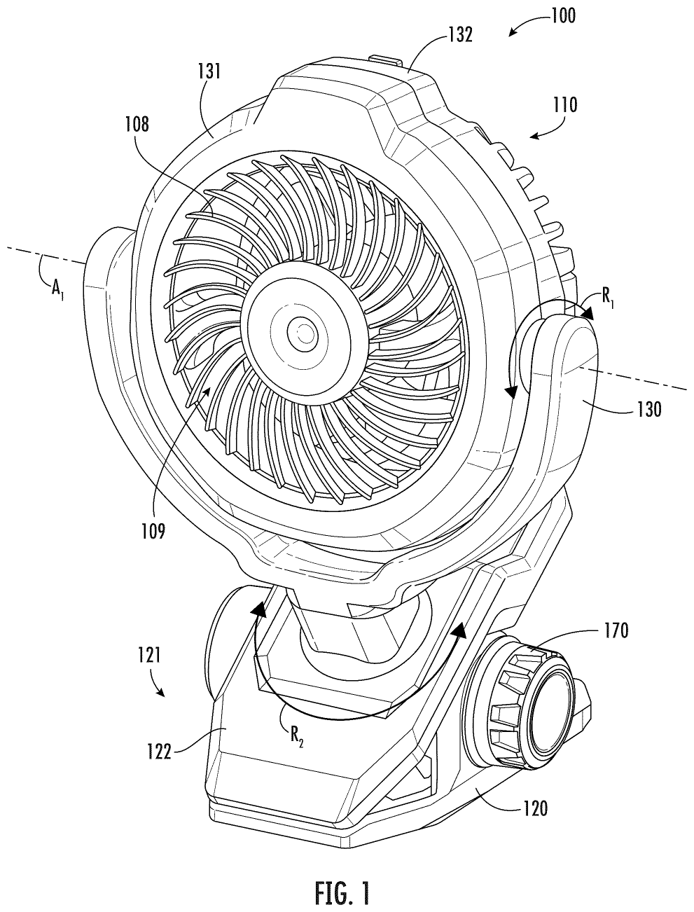

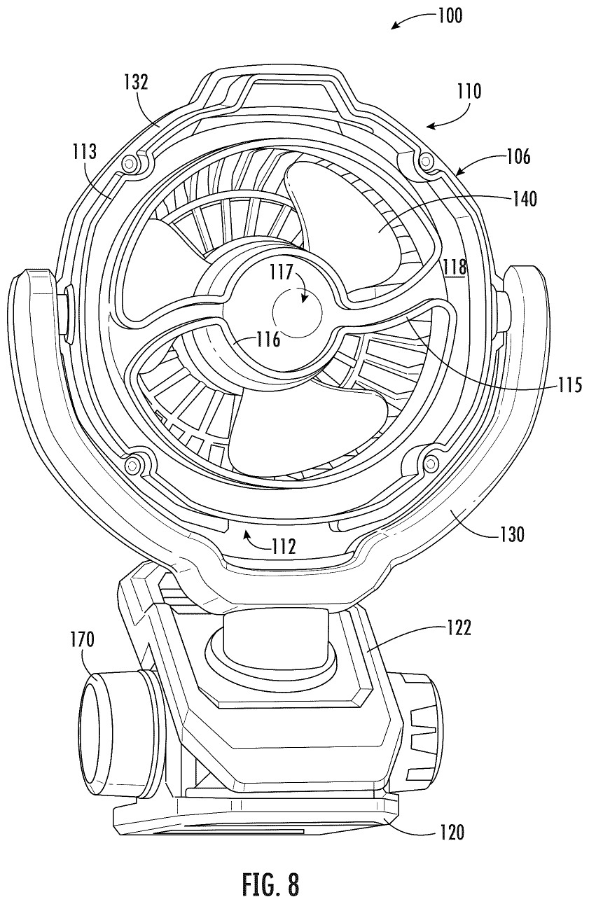

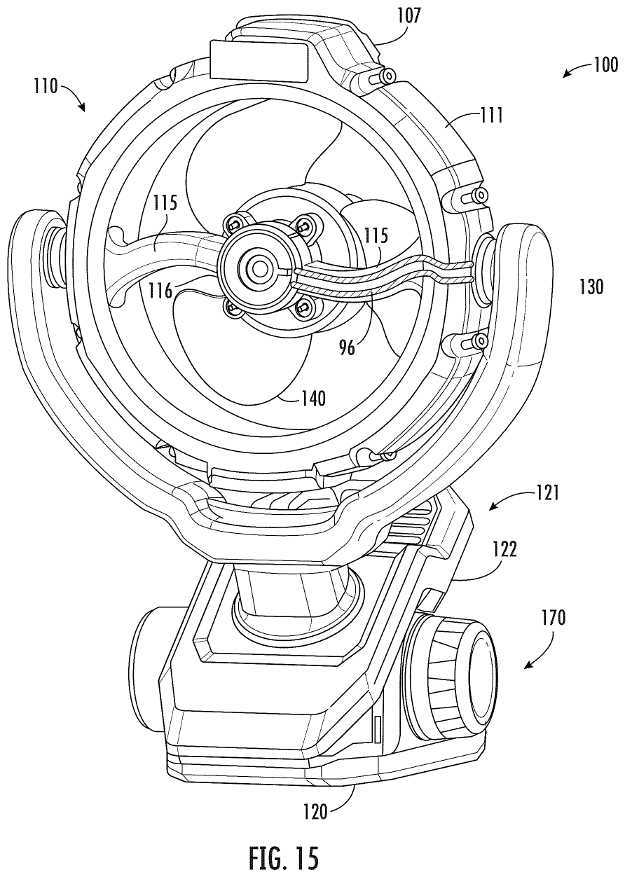

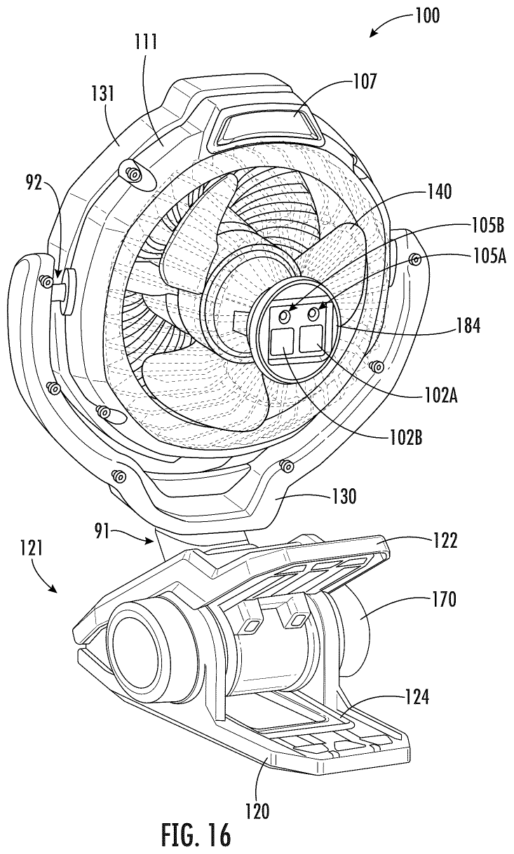

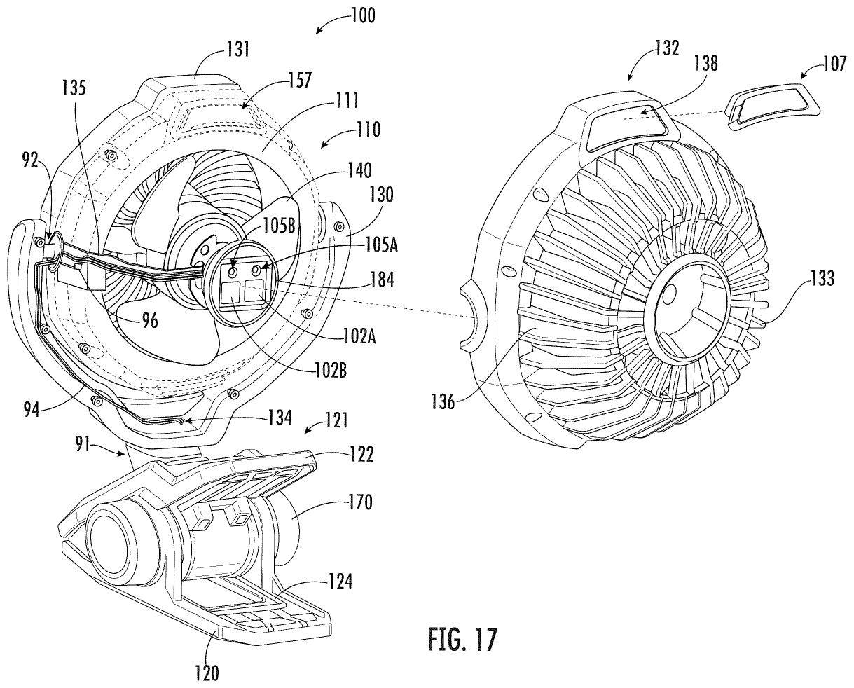

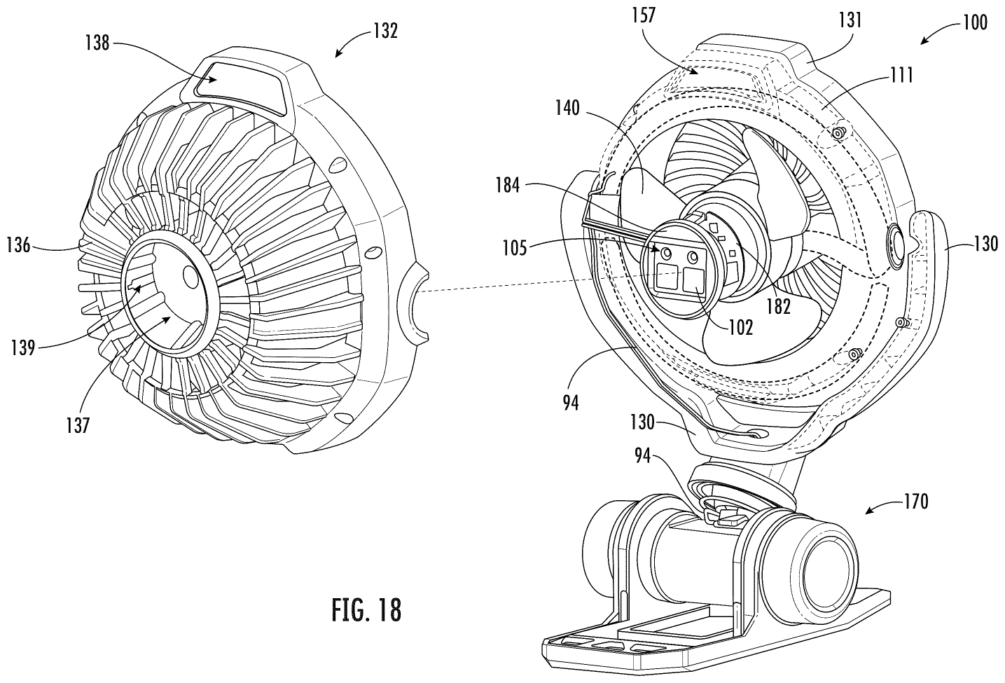

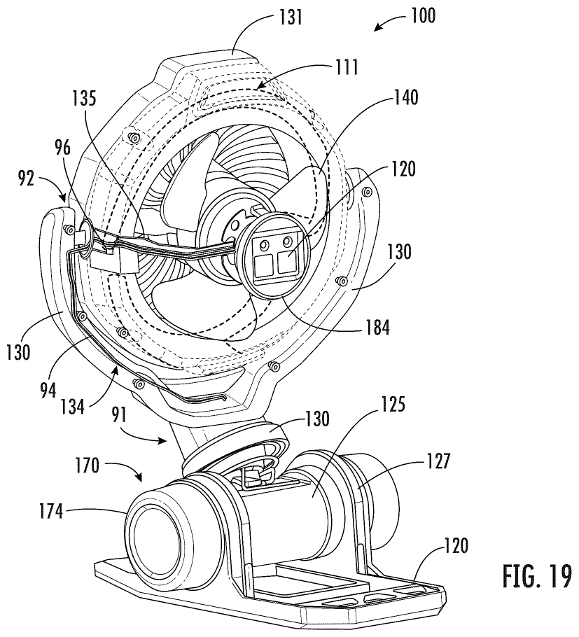

Referring now to the drawings, FIGS. 1-24 provide embodiments and views of a personal fan device 100. The fan device 100 includes a fan assembly 110. A base assembly 121 supports a mount 130 to which the fan assembly 110 is supported. As further described herein, the mount 130 may be configured to facilitate rotation of the fan assembly 110 along one or more axes. The fan assembly 110 includes a fan 140 powered by any suitable motive device, such as, but not limited to, a plug-in or battery-powered electric motor, a hand-operated motive device, or other desired power source.

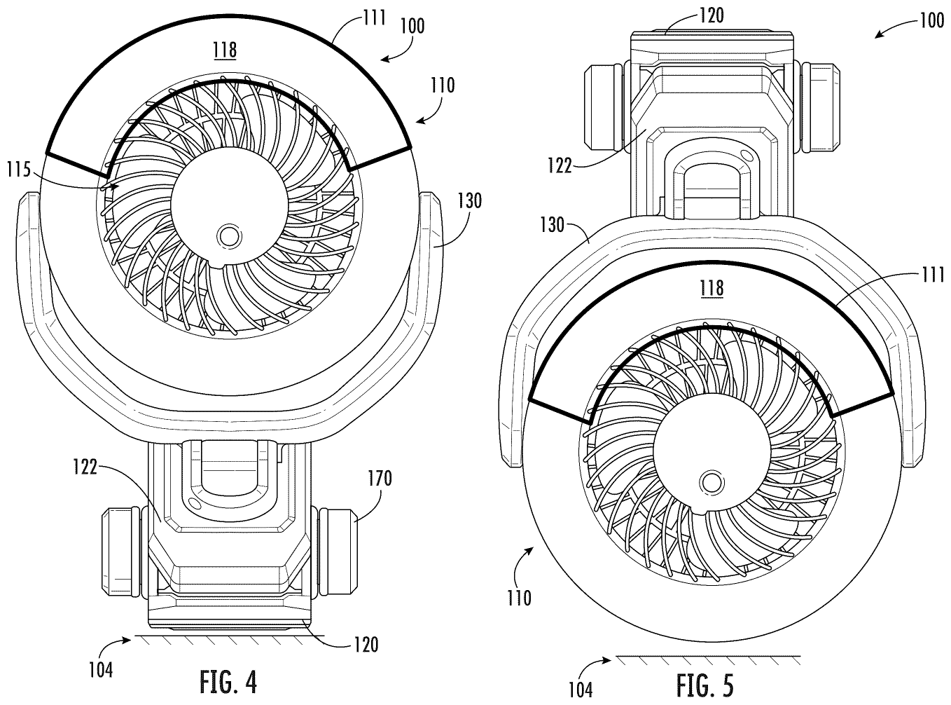

In various embodiments, the fan device 100 includes a mister assembly forming a plenum 118 at which a cooling fluid (e.g., water or water-based solution) is provided. Referring to FIGS. 4-5, in some embodiments, a casing 111 may form a circumferentially-extended plenum positioned between casings surrounding the fan 140. One or more manifold or vane 115 extends from an outer body 106 of the casing 111 toward a centerbody 116 to allow for the cooling fluid to egress into a fan flowpath 109 through which air from the fan 140 flows.

The fan flowpath 109 is formed generally along a flow direction of the fan 140. In some embodiments, the casing 111 may form or at least partially circumferentially shroud to form the fan flowpath 109. In still some embodiments, a fan case may include cases 131, 132. Cases 131, 132 may form, at least in part, the fan flowpath 109 surrounding the fan 140.

In various embodiments, the outer body 106 of the casing extends along an arcuate section or fully circumferentially, such as around the fan flowpath 109, such as depicted and described herein.

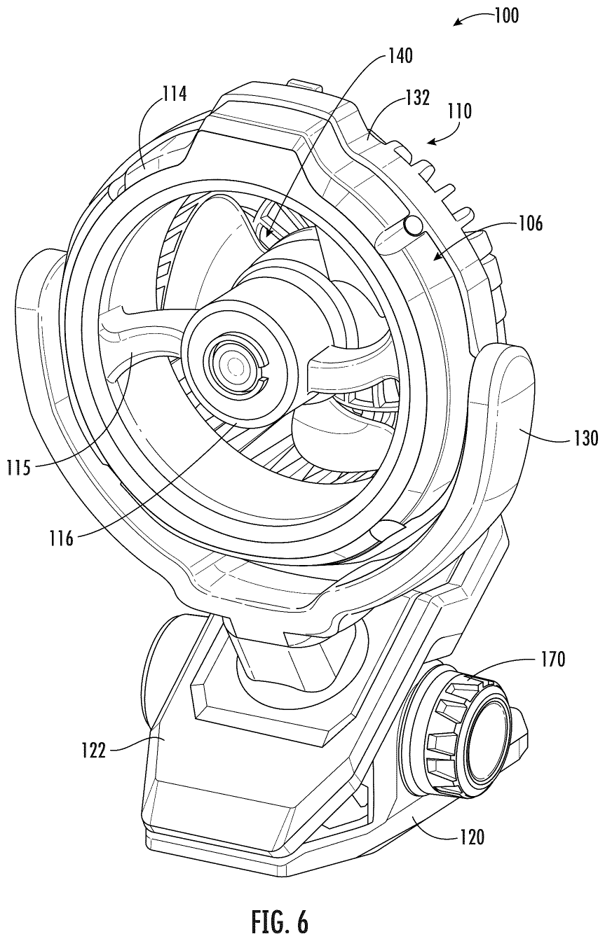

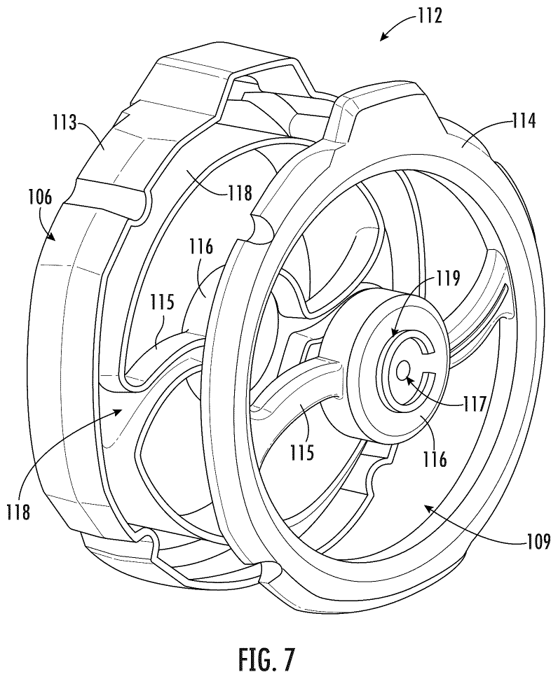

Referring to FIGS. 6-9, in various embodiments, the casing 111 may include portions, such as casing 113, 114, between which the plenum 118 is formed. In various embodiments, the casings 113, 114 form a tank that includes the plenum 118 and is configured to store cooling fluid in the plenum 118. The mister assembly 112 includes a centerbody 116 forming an opening 117 through which the cooling fluid is releasable from the plenum 118. For instance, cooling fluid may release through opening 117 in mist form into the flowpath 109.

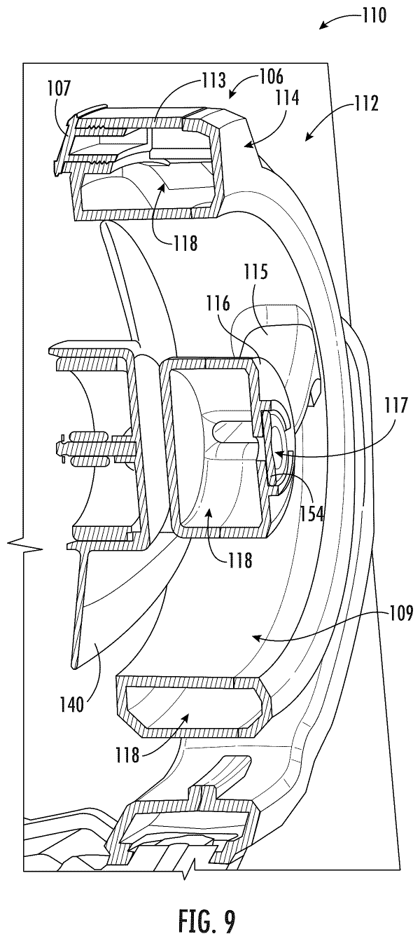

Referring briefly to FIG. 9 and FIGS. 17-18, casing 111 may form a fill opening 157 providing fluid access to the plenum 118. A plug 107 is selectively placeable at the opening 157 to seal the plenum 118. In some embodiments, the case 132 includes an opening 138 corresponding in position to the fill opening 157. Openings 138, 157 may allow a user to fill the plenum 118 with cooling fluid by selectively removing and extending the plug 107 into opening 138 at case 132 and opening 157 at casing 111.

In various embodiments, the mister assembly 112 forms the plenum 118 as a partially or fully circumferential flowpath, such as extending circumferentially around the centerbody 116, or as an arcuate section. The manifold or vane 115 extends between the centerbody 116 and the outer body 106 of the casings 113, 114 forming an outer ring (or, in some embodiments, an arcuate section of ring) extending along a circumferential direction around the centerbody 116. The plenum 118 extends through the vane 115 to provide fluid communication from the casing 113, 114 to the centerbody 116 and the opening 117.

In some embodiments, the casings 113, 114 include an aft casing 113 proximate to the fan 140 and a forward casing 114 distal to the fan 140 relative to the flow of air from the fan 140. In some embodiments, the aft and forward casings 113, 114 may be formed integrally. In still some embodiments, the aft and forward casings 113, 114 may be separable from and releasably attachable to one another.

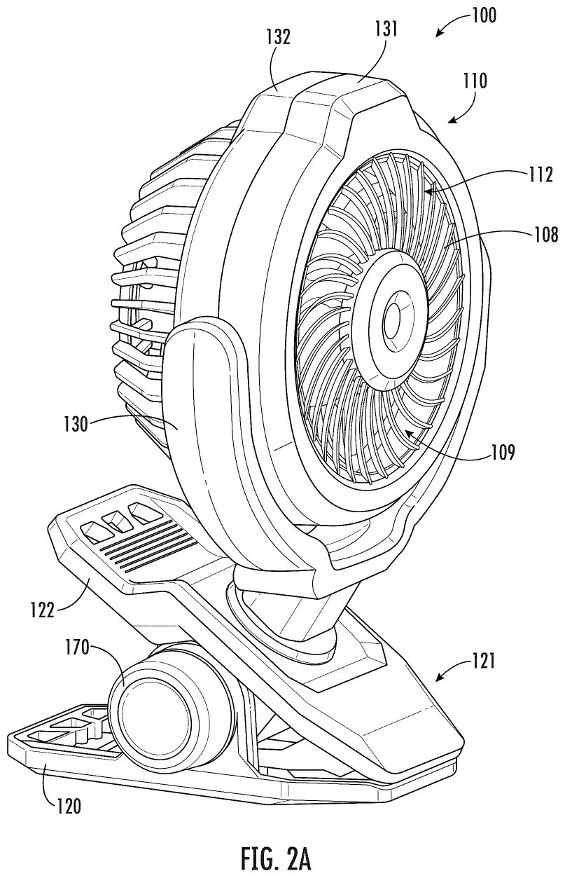

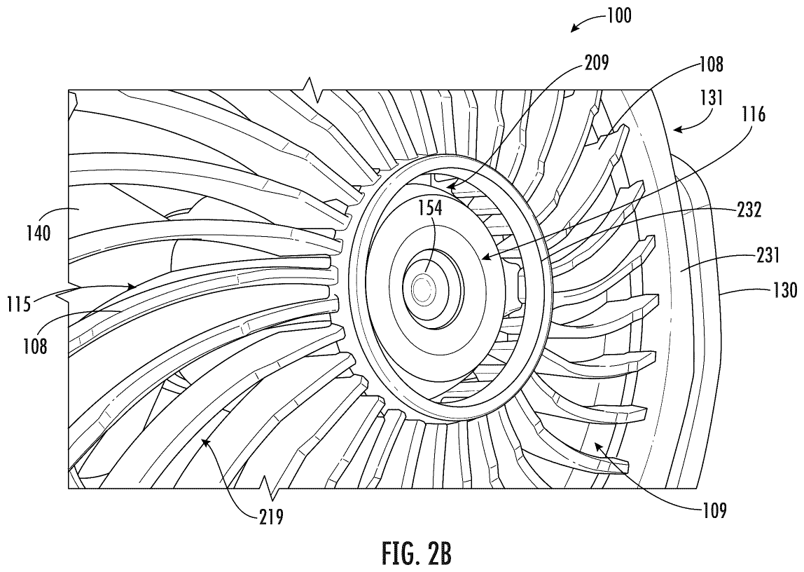

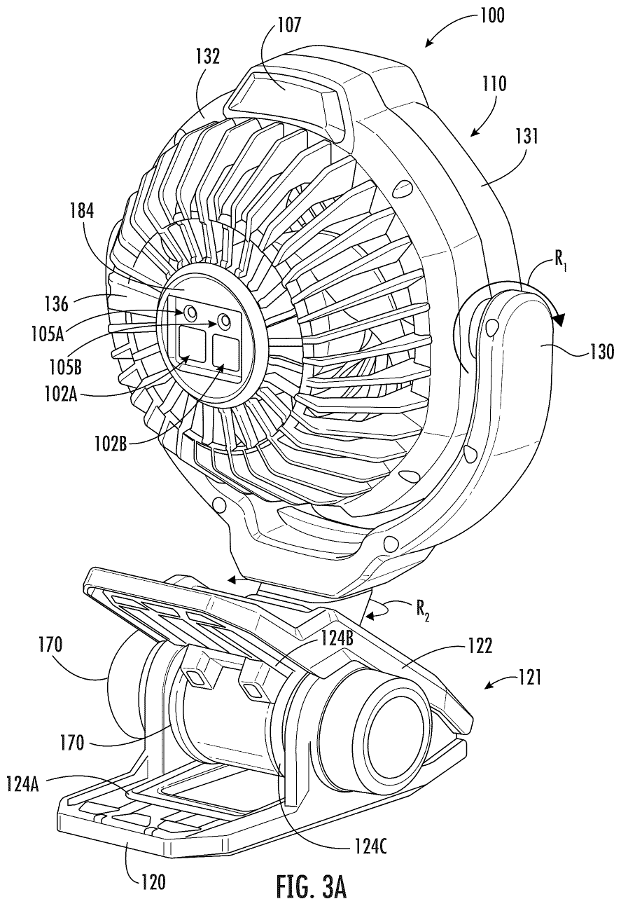

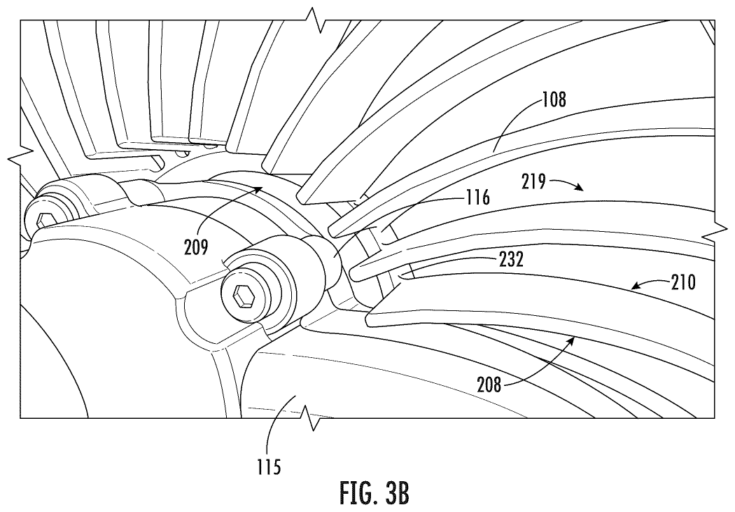

Referring back to FIGS. 1. FIGS. 2A-2B, and FIGS. 3A-3B, in various embodiments, at least a portion of the mister assembly 112 may be positioned or housed between front and rear cases 131, 132 (e.g., a first case and a second case). For instance, the outer body 106 of the mister assembly 112 may be housed between the front and rear cases 131, 132. The front case 131 may include a plurality of vanes 108 configured to direct and condition a flow of air from the fan 140. The rear case 132 may include a housing 133 for a motor for operating the fan 140. A control interface 102, such as buttons, switches, displays, indicators, or other control mechanisms, may be positioned at the housing 133, such as to articulate a fan speed, fan rotation, voltage intermittence, vibration, lighting, misting function, or other control function of the fan device 100.

Referring to FIG. 2B, a front view of a portion of an embodiment of the fan device 100 is depicted. Referring to FIG. 3B, a rear view of the portion of the embodiment of the fan device 100 is depicted. Referring to FIGS. 2B and 3B, in various embodiments, the front case 131 may include an outer body 231 and an inner body 232. The plurality of vanes 108 extend between the bodies 231, 232. For instance, bodies 231, 232 may include rings between which the plurality of vanes 108 extend radially. A flowpath 209 is formed between the inner body 232 and the centerbody 116. In some embodiments, inner body 232 is radially spaced from the centerbody 116. In still some embodiments, additionally, or alternatively, inner body 232 is axially spaced (e.g., separated along an extension of the flowpath 109) from the centerbody 116. Spacing between the inner body 232 and the centerbody 116 may allow a flow of air from the fan 140 through the flowpath 209 between the centerbody 116 and the inner body 232 of the front case 131. Air flow through the flowpath 209 may promote fluid communication with a flow of liquid from the plenum 118 to enhance generation of a mist, such as further described herein. For instance, the flowpath 209 may condition the air to facilitate atomization or misting of liquid egressing from the plenum 118 by generating a desired flow rate, pressure, direction, or vector of the air toward the liquid egressing from the plenum 118, such as further described herein.

Referring to FIG. 3B, in some embodiments, the plurality of vanes 108 may be cantilevered from the inner body 232, the outer body 231, or both. The plurality of vanes 108 may include a leading edge 208 extending toward the fan 140 (FIG. 2A) and separated from the inner body 232. For instance, the plurality of vanes 108 may extend toward fan 140 (FIG. 2A). The plurality of vanes 108 may extend radially outward of the flowpath 209. For instance, flowpath 109 may be separated at the inner body 232 into a first flowpath 219 radially outward of a second flowpath 209. The first flowpath 219 is formed between the inner body 232 and the outer body 231. Air flow through the second flowpath 209 may be conditioned differently from air flow across the first flowpath 219. For instance, the plurality of vanes 108 may condition the air through the first flowpath 219 differently from air passing through the second flowpath 209. The plurality of vanes 108 at the first flowpath 219, or differences in cross-sectional area, or presence or absence of other aerodynamic members and surfaces at the first flowpath 219 or second flowpath 209, may facilitate different air flow conditions for the misting function and for providing air to the user.

In some embodiments, a trailing edge 210 of the plurality of vanes 108 may connect to the inner body 232, the outer body 231, or both. However, it should be appreciated that a chord or body of the plurality of vanes 108 may additionally, or alternatively, connect to the inner body 232, the outer body 231, or both.

The cases 131, 132 may be fastened, clipped, snapped, or otherwise releasably attachable to one another. Separating the cases 131, 142 may allow a user to access a volume between the cases 131, 132 at which the mister assembly 112 is positioned. One or both of the cases 131, 132 may be attached to the mount 130. For instance, one or both of cases 131, 132 may be attached to the mount 130 in pivotable arrangement. In various embodiments, the mister assembly 112 is rotatable approximately +/−90 degrees, or up to approximately 180 degrees. For instance, the cases 131, 132 may orient the mister assembly 112 approximately +/−90 degrees along a first direction of rotation R₁ relative to an axis A₁ extending through a pivot point at the mount 130 (FIG. 1).

In still various embodiments, mount 130 may be rotatably connected to the base assembly 121. The base assembly 121 may be configured to rotate the mount 130 up to approximately 360 degrees, or up to approximately 350 degrees, such as along a second direction of rotation R₂.

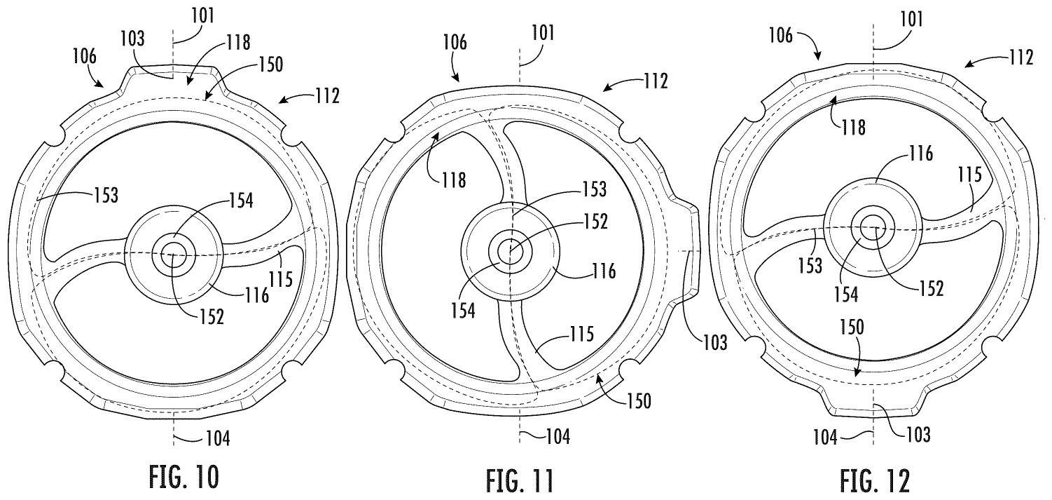

Referring now to FIGS. 10-13, in various embodiments, the mister assembly 112 may include a capillary structure 150 positioned in the plenum 118 and the opening 117. The capillary structure 150 may include a porous material, a wick, or flexible fabric strip, configured to draw or wick the cooling fluid in the plenum 118 through capillary action. In various embodiments, the capillary structure 150 may be positioned along walls of the casings 113, 114 that contain the plenum 118.

In still various embodiments, the capillary structure 150 extends through the outer body 106, the one or more vane 115, and to the opening 117 at the centerbody 116. The capillary structure 150 may be extended circumferentially through the plenum 118 between the casings 113, 114 and through the one or more vane 115 to the centerbody 116 and opening 117. The capillary structure 150 may facilitate pulling cooling fluid from the plenum 118 and through the opening 117 into fluid communication with the flow of air from the fan 140. The capillary structure 150 may further facilitate pulling the cooling fluid from the plenum 118 and through the opening 117 from any orientation of the fan device 100 along directions of rotation R₁, R₂.

For instance, FIGS. 10-12 include a schematic top dead center (TDC) reference 101 and a schematic mister assembly positioning reference 103. FIGS. 10-12 depict various rotations of the mister assembly 112 relative to the TDC reference 101. The capillary structure 150 may facilitate pulling cooling fluid from a bottom portion of the plenum 118, such as depicted schematically at bottom dead center (BDC) reference 104. Embodiments of the capillary structure 150 may allow the cooling fluid to be pulled from various rotational positions of the mister assembly 112 relative to a direction of gravitational pull (e.g., toward the BDC reference, or toward the ground), such as depicted in various orientations of the fan device 100 in FIGS. 10-12.

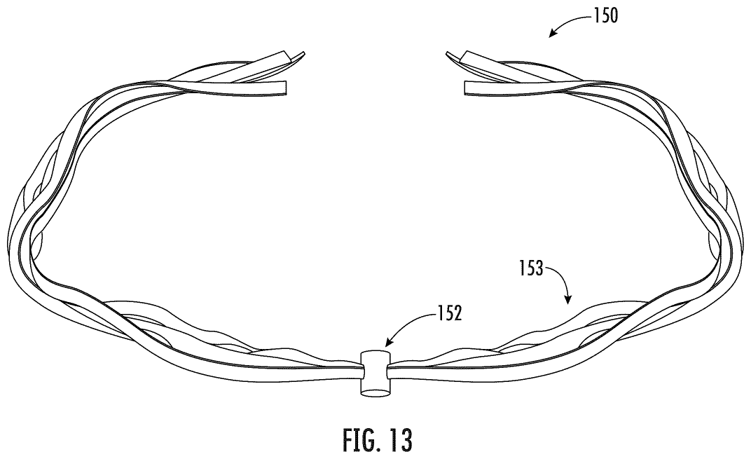

In still various embodiments, the capillary structure 150 may include a central body 152 disposable at the opening 117. The central body 152 may form a cylindrical portion, or other geometry corresponding to the opening 117, of the capillary structure 150. As shown in FIG. 13, a plurality of strands, strips, or lengths 153 of capillary structure may extend from the central body 152. The plurality of strands, strips, or lengths 153 of capillary structure may extend from the central body 152 and dispose through the plenum 118 contained at one or more of the vane 115, the outer body 106, the centerbody 116, or combinations thereof.

In some embodiments, a misting disc 154 may be positioned adjacent to the capillary structure 150 at the centerbody 116. For instance, the misting disc 154 may be positioned adjacent to the central body 152 of the capillary structure 150. In various embodiments, the centerbody 116 may form a groove 119 at which the misting disc 154 is disposable. The groove 119 may extend around opening 117, such as to position the misting disc 154 to receive cooling fluid from the plenum 118 at the centerbody 116. For instance, the central body 152 may be positioned behind the misting disc 154 to pull cooling fluid from any orientation of the plenum 118. In still various embodiments, the capillary structure 150 may facilitate pulling cooling fluid notwithstanding a volume or quantity of fluid in the plenum 118, such as resulting from the length, flexibility, or volume of the capillary structure 150 in the plenum 118.

In some embodiments, the misting disc 154 includes a porous material, such as a micro-mesh material. The misting disc 154 is positioned in fluid communication with the plenum 118 to receive cooling fluid from the plenum 118. The misting disc 154 may be positioned in fluid communication with the plenum 118 through opening 117. The opening 117 may allow the cooling fluid to migrate through the misting disc 154 into fluid communication with the flow of air from the fan 140. The cooling fluid released from the misting disc 154 into the flow of air from the fan 140 may atomize into a mist, such as to improve cooling effectiveness of the fan device 100.

In still some embodiments, the misting disc 154 forms a piezo disc or atomizer disc configured to vibrate based on an intermittent voltage input at the fan device 100. An intermittent voltage may be controlled by a controller 182, such as a printed circuit board assembly (PCBA), to vibrate the misting disc 154. For instance, an intermittent voltage input at the motor for operating the fan 140 may vibrate the misting disc 154. The vibration may pull cooling fluid from a backside of the misting disc 154 (e.g., from the plenum 118 at the centerbody 116) through a micro-mesh of the misting disc 154. The vibration may push the cooling fluid from the misting disc 154 to the flow of air from the fan 140 (e.g., flow of air along flowpath 109), such as to cause a mist of cooling fluid and air.

The controller 182 may include a circuit board operably coupled to the control interface 102. In some embodiments, the controller 182 is configured as a PCBA or other appropriate electronic configuration for receiving and transmitting control signals and operating the fan assembly 110. In some embodiments, the control interface 102 includes buttons 102A, 102B. For instance, buttons 102A, 102B may be configured to allow for separate command and control of fan operation (e.g., ON/OFF or one or more speeds) and vibration speed for operating the misting disc 154.

In various embodiments, the first button 102A may be configured as a fan control button to command or control operation of the fan 140. Articulation of the first button 102A may command ON/OFF function of the fan 140 and articulation of the second button 102B may command ON/OFF function of the misting assembly 112. Articulation of the button 102A may further command changes in fan speed or cycle through one or more fan speeds. For instance, in an exemplary embodiment of operation, pressing the first button 102A (e.g., pressing once or initially the first button 102A) configured as a fan control button commands operation of the fan 140 to a high speed operation; pressing the first button 102A one or more additional instances commands one or more lower speed operations of the fan 140; and pressing the first button 102A an additional sequential instance discontinues operation of the fan 140. In various embodiments, discontinuing operation of the fan 140, or articulating the first button 102A to discontinue operation of the fan 140, furthermore discontinues operation of the misting function at the misting assembly 112 (e.g., discontinues voltage input for vibrating the misting disc 154). For instance commanding OFF operation of the fan 140 using the first button 102A may further command OFF operation of the misting assembly 112.

The controller 182 may be configured to provide a time limit for operating the misting function. In various embodiments, the controller 182 includes a timer configured to stop vibration of the misting disc 154. The controller 182 including the timer may include the time limit corresponding to a predetermined amount of time to substantially or completely exhaust cooling fluid from the plenum 118. The controller 182 may be configured to operate the misting disc 154 for a predetermined amount of time extending from when a button (e.g., button 102B) is articulated to command operation of the misting assembly 112. For example, the controller 182 may include a two-hour time limit for operating the misting disc 154, or other appropriate amount of time based on the lengths, volumes, areas, flowpaths, flowrates, or material properties associated with the plenum 118, the capillary structure 150, the misting disc 154, or other structures that may affect a rate at which cooling fluid may be substantially or fully removed from the plenum 118. In various embodiments, the controller 182 includes software or firmware providing the time limit stored and executed by the controller 182. In some embodiments, the controller 182 includes hardware, such as circuitry, busses, etc., providing the time limit such as described herein. Embodiments of the fan device 100 including the timer at the controller 182 such as described herein may prevent damage to components of the fan device 100 that may be adversely affected by dry operation of the misting function 112, such as, but not limited to, the misting disc 154.

The controller 182 may include a lighting device 105. In various embodiments, the lighting device 105 may be configured as a light-emitting diode (LED) or other light-emitting device. The lighting device 105 may be configured to indicate to the user whether various controls or controls are commanded. For instance, the lighting device 105 may be configured to indicate whether the misting function is commanded or whether fan operation is commanded (e.g., ON/OFF of the fan 140, or one or more rotational speeds of the fan 140). In some embodiments, a first lighting device 105A may correspond to articulation at button 102A, and a second lighting device 105B may correspond to articulation at button 102B. The first button 102A may be configured to command or control operation of the fan 140, and the first lighting device 105A may be configured to indicate whether operation of the fan 140 is commanded. The second button 102B may be configured to command or control operation of the misting function (e.g., ON/OFF of vibrations to generate a mist), and the second lighting device 105B may be configured to indicate whether operation of the misting function is commanded, such as further described herein.

It should be appreciated that, in various embodiments, the lighting device 105 may be configured to provide or discontinue provision of light, or provide various colors, or provide various outputs of lumens, or combinations thereof.

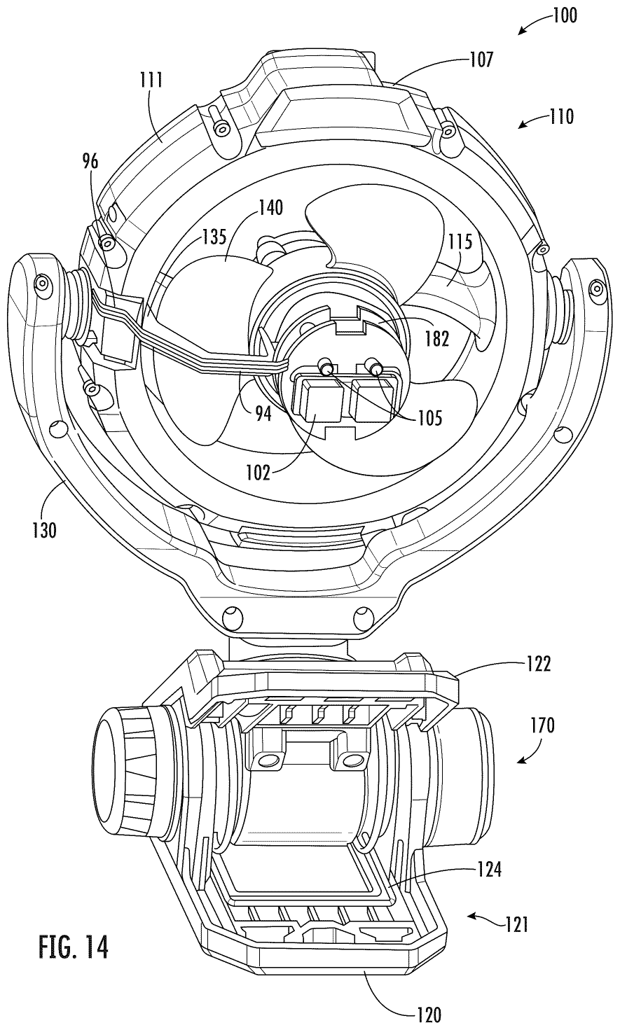

Referring to FIGS. 14-21, in various embodiments, one or more arms 135 extends between the mount 130 and the housing 133. The arm 135 may include a member extending from mount 130 to housing 133 to provide a bridge along which electrical wires may extend. In some embodiments, casing 132 includes a rib 136 corresponding to the arm 135. The rib 136 may provide an outer cover concealing wires 94, 96 routing across arm 135. In still some embodiments, arm 135 and rib 136 correspond circumferentially to vane 115. For instance, arm 135, rib 136, and vane 115 may each extend from respective center portions and occupy similar angular locations as one another. The arm 135, rib 136, and vane 115 positioned in similar angular locations may minimize obstructions to the fan flowpath 109 while facilitating routing of electrical wires for operating the fan assembly such as described herein.

In some embodiments, electrical wires 96 route from the housing 133 across the arm 135. For instance, wires 96 may electrically couple to the controller 182 at the housing 133. Wires 96 route over the arm 135 and vane 115 to the centerbody 116. The wires 96 may extend over vane 115 and in electrical communication with the misting disc 154. Controller 182 may command an intermittent voltage input across wires 96 for vibrating the misting disc 154 and generating the mist of cooling fluid and air.

Embodiments of the arm 135 and vane 115 may provide electrical routing along substantially external surfaces of the fan device 100. Routing along external surfaces may facilitate construction and assembly of the fan device and provision of electrical power for misting functions and fan operation.

Referring to FIGS. 14-21, in various embodiments, the base assembly 121 may include a base wall 120. The base wall 120 may form a platform configured to rest against a wall, ground, or other surface at which the fan device 100 may be positioned. The mount 130 may extend from a mount wall 122.

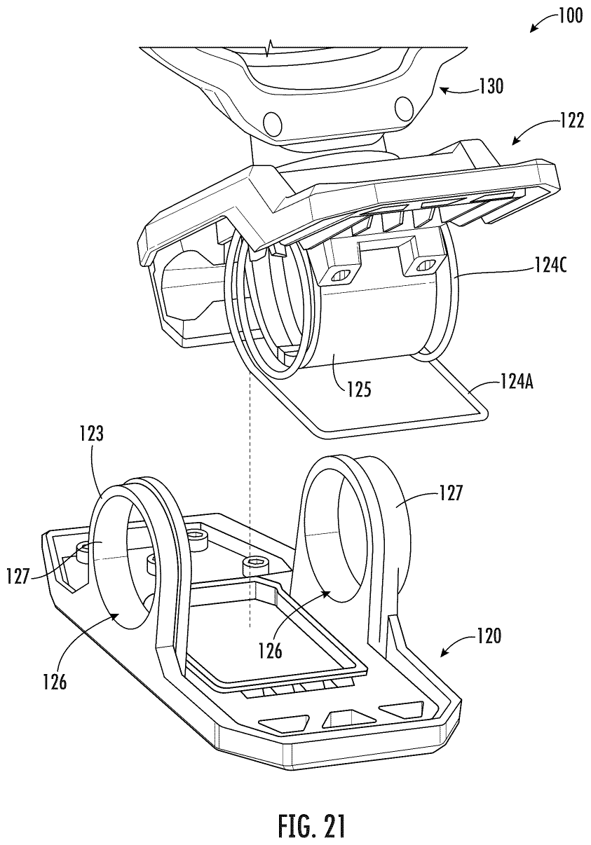

In various embodiments, such as depicted in FIG. 21, a spring 124 is coupled to the mount wall 122 and the base wall 120. The spring 124 may be configured to position the mount wall 122 relative to the base wall 120. For instance, the spring 124 may include a spring clip configured to provide a reactive force relative to a force received at the mount wall 122 toward the base wall 120, or a force received at the base wall 120 toward the mount wall 122.

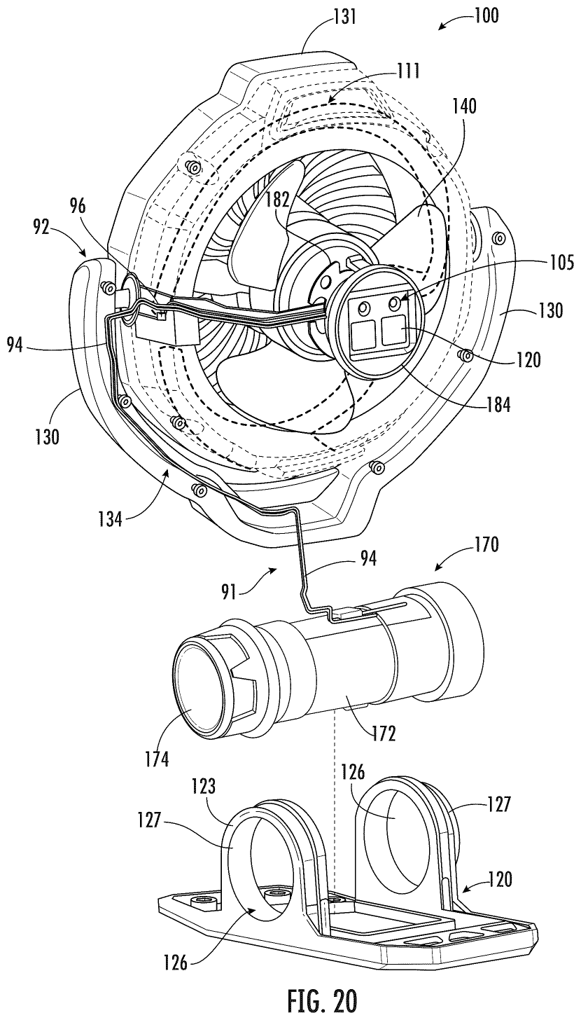

Referring to FIGS. 20-21, the base assembly 121 forms a storage channel 126 between the mount wall 122 and the base wall 120. In some embodiments, the base wall 120 forms a port 127 into which a battery assembly 170 is receivable at the base assembly 121. The port 127 includes a wall or surface 123 at the base wall 120 extending at least partially along an extension of the storage channel 126. For instance, the wall or surface 123 may form a ring, an arcuate section, or sleeve forming the port 127 and at least a portion of the storage channel 126.

In some embodiments, a sleeve 125 is positioned between the mount wall 122 and the base wall 120. The sleeve 125 may form a portion of the storage channel 126. For instance, the sleeve 125 may position between a pair of ports 127. In still some embodiments, the spring 124 forms a spring clip allowing for extension of the battery assembly 170 through the spring 124. The spring 124 may include portions positioned in alignment to form a portion of the storage channel 126 through the spring 124. For instance, the spring 124 may include a first spring portion 124A configured to react against the base wall 120. The spring 124 may include a second spring portion 124B configured to react against the mount wall 122. The spring 124 may include an intermediate portion 124C into which the battery assembly 170 is extendable from the port 127.

Referring to FIGS. 19-20, in various embodiments, the battery assembly 170 may form an elongated structure extending co-directional to the extension of the storage channel 126. The battery assembly 170 may include an outer housing 172 forming a substantially cylindrical outer wall. The battery assembly 170 may include one or more removable end caps 174 configured to selectively attach and release from the outer housing 172. The user may access an internal volume of the outer housing 172 by removing the end cap 174. For instance, the user may access one or more batteries within the outer housing 172, or other operable components of the battery assembly 170.

In an exemplary, non-limiting embodiment, the battery assembly 170 may be configured as a four (4) Volt (V) power supply. In still various embodiments, the battery assembly 170 may be configured as a 4V connectable to a universal serial bus (USB) power supply to receive or discharge energy.

Referring to FIGS. 14-21, in various embodiments, the mount 130 includes a passage 134. The passage 134 forms a conduit to facilitate routing electrical wires 94 from the battery assembly 170 for operation of one or more of the control interface 102 or fan 140. The passage 134 may extend at a first end to a first attachment interface 91 at which the mount 130 attaches to the base assembly 121. The passage 134 may extend at a second end to a second attachment interface 92 at which the fan assembly 110 attaches to the mount 130.

The passage 134 may extend from the housing 130 at the second interface 92 and through the arm 135 to the housing 133 to facilitate routing electrical wires 94 for operable connection to a controller 182 at the housing 133. The housing 133 may form a volume 137 configured to receive the controller 182 for operating the fan assembly 110. Casing 132 may include an opening 139 providing access from the volume 137 to passage 134 along arm 135 and rib 136. Opening 139 may form a hole, slit, or slot. For instance, the opening 139 may extend from arm 135, such as to allow a user to selectively remove and attach the casing 132 to the fan assembly 110 without interfering with wires 96 routing along arm 135.

In some embodiments, control interface 102 is positioned at an end cap 184. The end cap 184 is attachable to the housing 133 at the casing 132. The end cap 184 may cover the volume 137. For instance, the housing 133 and end cap 184 may provide an enclosed volume at which the controller 182 is positioned within the casing 132. In some embodiments, end cap 184 is operably coupled to controller 182 and control interface 102 to receive user input signals and transmit the signals to controller 182 for controlling fan operation and misting function.

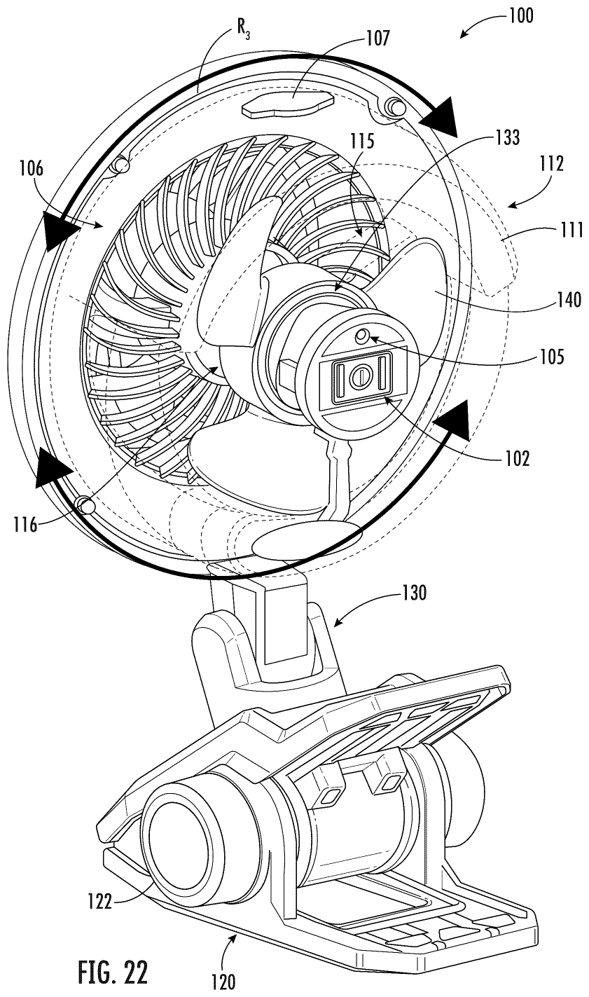

Referring now to FIGS. 22-24, in some embodiments, the mister assembly 112 may include casing 111 forming the plenum 118 at which the cooling fluid (depicted schematically at 156) is retained. The casing 111 may form a unitary casing extending at least over an arcuate section. The casing 111 may include plug 107 forming a removable cover providing access into the plenum 118 and sealing to prevent the cooling fluid from leaking therethrough. In some embodiments, the plenum 118 may form an arcuate section extending along a circumferential direction, such as corresponding to a direction of rotation of the fan 140.

Referring to FIG. 22, in some embodiments, the casing 111 may be configured to rotate along a direction of rotation R₃, such as corresponding to a circumferential direction or axis around which the fan 140 rotates. A user may rotate the casing 111 to position the lowest point of the plenum 118 above the misting disc. For instance, casing 111 may form the plenum 118 as an arcuate section extending along the direction of rotation R₃. The plenum 118 forming the arcuate section may include a lowest portion 99 positionable above the center of the fan device 100 at which the misting disc 154 is positioned. The rotatable plenum 118 may form a gravity feed that positions the plenum 118 above the misting disc 154 to feed water to the misting disc. (rotation of the tank may be achieved by either (a) manually rotating the tank or (b) using a weight on the opposite side of the tank),

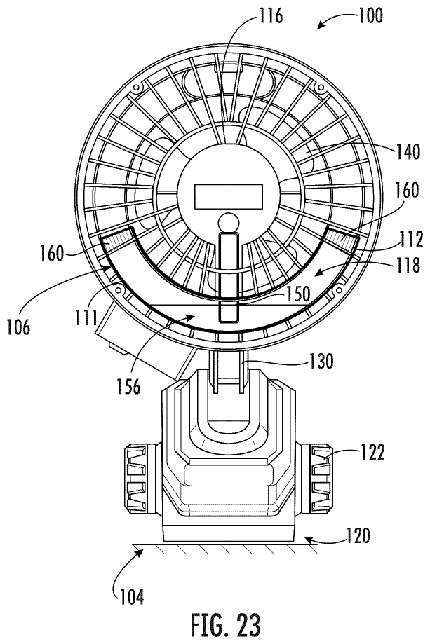

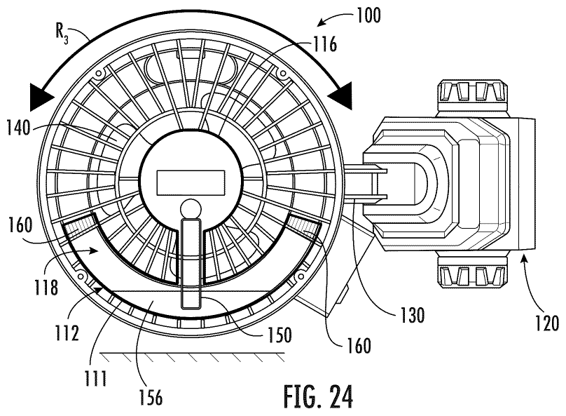

Referring to FIGS. 23-24, in some embodiments, a weight or mass 160 may be positioned at the casing 111, such as at the plenum 118. The mass 160 may bias the casing 111 to rotate to a bottom position based on gravity. For instance, FIGS. 23-24 depict a schematic BDC reference 104 corresponding to a ground. The fan device 100 may be positioned at the ground, or on a plane parallel thereto, such as depicted in FIG. 23. The fan device 100 may be positioned on a wall or other non-parallel plane relative to the ground, such as depicted in FIG. 24. The mass 160 rotates the casing 111 along the direction of rotation R₃.

Referring still to FIGS. 22-24, embodiments of the capillary structure 150 may extend from the centerbody 116 to the casing 111 through vane 115, such as described herein. In some embodiments, the capillary structure 150 may extend to a central portion or nadir of the arcuate section of casing 111, such as to receive cooling fluid 156 collected or pooled by gravity in the casing 111. For instance, mass 160 may rotate the casing 111 such as to position cooling fluid 156 at the nadir of the arcuate section (e.g., corresponding to a BDC location). The plenum 118 may be manually rotated by the user, or weighed down by masses 160, to position the cooling fluid 156 below the misting disc 154. The capillary structure 150 extends to the lowest portion at the plenum 118 to extract the cooling fluid 156 from the plenum 118.

Embodiments of the fan device 100 depicted and described herein may provide a portable air flow device configured to be moved and articulated by a user to provide a cooled flow of air in one or more directions. Embodiments of the mister assembly 112 may further provide a mist of water or water-based fluid to the flow of air, such as to improve cooling effectiveness. Embodiments of the mister assembly 112 may further overcome challenges regarding a positioning of fluid within a plenum relative to a gravitational direction. For instance, masses, capillaries, or plenums depicted and described herein may overcome such issues and facilitate substantially all of a cooling fluid, such as water or water-based solution, to egress into the cooling air notwithstanding a mounting, orientation, or direction of rotation of the fan device.

Further aspects and embodiments of the present subject matter are provided in the following clauses:
1. A fan device including a fan configured to provide a flow of air through a fan flowpath; and a mister assembly including a casing, the casing including an outer body, a centerbody, and a vane extending between the outer body and the centerbody, wherein a plenum is formed in the casing to store a cooling fluid, the plenum extending through the outer body, the vane, and the centerbody, and wherein the centerbody includes an opening through which the cooling fluid is releasable from the plenum into fluid communication with the flow of air.
2. The fan device of any one or more clauses herein, wherein the outer body extends circumferentially around the fan flowpath.
3. The fan device of any one or more clauses herein, wherein the outer body extends along an arcuate section around the fan flowpath.
4. The fan device of any one or more clauses herein, wherein the casing includes a capillary structure positioned in the plenum.
5. The fan device of any one or more clauses herein, wherein the capillary structure extends through the outer body, the vane, and to the opening of the centerbody.
6. The fan device of any one or more clauses herein, wherein the mister assembly includes a misting disc positioned adjacent to a portion of the capillary structure disposed at the centerbody, wherein the misting disc includes a porous material positioned in fluid communication with the plenum to flow the cooling fluid through the misting disc and to generate a mist into the flow of air from the fan.
7. The fan device of any one or more clauses herein, wherein the centerbody includes a groove configured to receive the misting disc.
8. The fan device of any one or more clauses herein, wherein the misting disc is positioned adjacent to a central body of the capillary structure positioned at the opening of the centerbody.
9. The fan device of any one or more clauses herein, wherein the misting disc includes a piezo disc or atomizer disc configured to vibrate when input with an intermittent voltage.
10. The fan device of any one or more clauses herein, further including fan case forming the fan flowpath, wherein the fan case houses at least a portion of the casing of the mister assembly.
11. The fan device of any one or more clauses herein, including a base; and a mount rotatably coupled to the base, wherein the fan and the mister assembly are supported by the mount.
12. The fan device of any one or more clauses herein, wherein the fan, the mister assembly, and the mount are rotatable relative to the base about a first axis.
13. The fan device of any one or more clauses herein, wherein the fan and the mister assembly are rotatable relative to the mount about a second axis.
14. The fan device of any one or more clauses herein, wherein the base includes a spring clip and the mount includes a yoke mount.
15. The fan device of any one or more clauses herein, wherein the outer body of the casing includes a second opening through which the plenum is fillable with the cooling fluid.
16. A fan device, including a fan configured to provide a flow of air through a fan flowpath; and a mister assembly including a casing, wherein the fan flowpath at least partially passes through a space surrounded by a periphery of the casing, wherein a plenum is formed in the casing to store a cooling fluid, and wherein the casing includes an opening through which the cooling fluid is releasable from the plenum into fluid communication with the flow of air.
17. The fan device of any one or more clauses herein, wherein the casing includes an outer body that extends along a circumferential direction relative to the fan flowpath and that surrounds the space.
18. The fan device of any one or more clauses herein, wherein the casing includes an outer body, a centerbody that includes the opening, and a vane extending between the outer body and the centerbody, the casing further includes a capillary structure positioned in the plenum, and wherein the capillary structure extends through the outer body, the vane, and to the opening of the centerbody.
19. The fan device of any one or more clauses herein, wherein the mister assembly includes a misting disc positioned adjacent to a portion of the capillary structure disposed at the centerbody, wherein the misting disc includes a porous material positioned in fluid communication with the plenum to flow the cooling fluid through the misting disc and to generate a mist into the flow of air from the fan.
20. The fan device of any one or more clauses herein, wherein the casing includes an outer body, a centerbody that includes the opening, and a vane extending between the outer body and the centerbody, and the fan flowpath at least partially passes through two spaces that are surrounded by the outer body and separated from one another by the vane and the centerbody.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A fan device, comprising:
a fan configured to provide a flow of air through a fan flowpath; and
a mister assembly comprising a casing, the casing comprising an outer body, a centerbody, and a vane extending between the outer body and the centerbody, wherein a plenum is formed in the casing to store a cooling fluid, the plenum extending through the outer body, the vane, and the centerbody, and wherein the centerbody includes an opening through which the cooling fluid is releasable from the plenum into fluid communication with the flow of air.

2. The fan device of claim 1, wherein the outer body extends circumferentially around the fan flowpath.

3. The fan device of claim 1, wherein the outer body extends along an arcuate section around the fan flowpath.

4. The fan device of claim 1, wherein the casing includes a capillary structure positioned in the plenum.

5. The fan device of claim 4, wherein the capillary structure extends through the outer body, the vane, and to the opening of the centerbody.

6. The fan device of claim 4, wherein the mister assembly includes a misting disc positioned adjacent to a portion of the capillary structure disposed at the centerbody, wherein the misting disc includes a porous material positioned in fluid communication with the plenum to flow the cooling fluid through the misting disc and to generate a mist into the flow of air from the fan.

7. The fan device of claim 6, wherein the centerbody includes a groove configured to receive the misting disc.

8. The fan device of claim 6, wherein the misting disc is positioned adjacent to a central body of the capillary structure positioned at the opening of the centerbody.

9. The fan device of claim 6, wherein the misting disc includes a piezo disc or atomizer disc configured to vibrate when input with an intermittent voltage.

10. The fan device of claim 1, further comprising:
a fan case forming the fan flowpath, wherein the fan case houses at least a portion of the casing of the mister assembly.

11. The fan device of claim 1, comprising:
a base; and
a mount rotatably coupled to the base, wherein the fan and the mister assembly are supported by the mount.

12. The fan device of claim 11, wherein the fan, the mister assembly, and the mount are rotatable relative to the base about a first axis.

13. The fan device of claim 12, wherein the fan and the mister assembly are rotatable relative to the mount about a second axis.

14. The fan device of claim 11, wherein the base includes a spring clip and the mount includes a yoke mount.

15. The fan device of claim 1, wherein the outer body of the casing includes a second opening through which the plenum is fillable with the cooling fluid.

16. A fan device, comprising:
a fan configured to provide a flow of air through a fan flowpath; and
a mister assembly comprising a casing, wherein the fan flowpath at least partially passes through a space surrounded by a periphery of the casing, wherein a plenum is formed in the casing to store a cooling fluid, and wherein the casing includes an opening through which the cooling fluid is releasable from the plenum into fluid communication with the flow of air.

17. The fan device of claim 16, wherein the casing includes an outer body that extends along a circumferential direction relative to the fan flowpath and that surrounds the space.

18. The fan device of claim 16, wherein the casing includes an outer body, a centerbody that includes the opening, and a vane extending between the outer body and the centerbody, the casing further includes a capillary structure positioned in the plenum, and wherein the capillary structure extends through the outer body, the vane, and to the opening of the centerbody.

19. The fan device of claim 18, wherein the mister assembly includes a misting disc positioned adjacent to a portion of the capillary structure disposed at the centerbody, wherein the misting disc includes a porous material positioned in fluid communication with the plenum to flow the cooling fluid through the misting disc and to generate a mist into the flow of air from the fan.

20. The fan device of claim 16, wherein the casing includes an outer body, a centerbody that includes the opening, and a vane extending between the outer body and the centerbody, and the fan flowpath at least partially passes through two spaces that are surrounded by the outer body and separated from one another by the vane and the centerbody.
